(19) United States
(12) Patent Application Publication
(10) Pub. No.: US 2015/0007832 A1
(43) Pub. Date: Jan. 8, 2015

(54) PATIENT TRANSPORTER WITH EXPANDABLE/DEPLOYABLE SUPPORT STRUCTURE

(71) Applicant: Paper-Pak Industries, Laverne, CA (US)

(72) Inventors: Ronald Jensen, Chicago, IL (US); Richard Beu, Yorba Linda, CA (US); Sayandro Versteylen, Fontana, CA (US)

(21) Appl. No.: 14/364,230

(22) PCT Filed: Dec. 10, 2012
(86) PCT No.: PCT/US2012/068838

§ 371 Date: Jun. 10, 2014

Related U.S. Application Data
(60) Provisional application No. 61/569,250, filed on Dec. 10, 2011.

(51) Int. Cl. A61G 1/052

(52) U.S. Cl. CPC A61G 1/052; A61G 2001/042
USPC 128/870

(57) ABSTRACT

A patient transporter having a deployable expandable support structure that provides “semi-rigid” to “rigid” additional support to the patient transporter is provided. A method of using the patient transporter by deploying the expandable support structure is also provided.

### BACKGROUND OF THE DISCLOSURE

1. Field of Disclosure

The present disclosure relates to a patient transporter that has an expandable or deployable support structure. The deployment of the support structure provides a semi-rigid to rigid additional support for the patient on the transporter.

2. Description of Related Art

Patient transporters that carry injured patients or soldiers may sag in the middle, where the person's weight is centered. A large board or frame made of wood or metal can be used to stiffen and provide additional support beneath the patient.

However, conventional supports such as a wood board or metal frame, are large, heavy, and consume a large amount of space before use, and are impractical to be stored, shipped or carried. Also, conventional supports are often uncomfortable to a patient.

### SUMMARY OF THE DISCLOSURE

There is provided a patient transporter that has a deployable expandable support structure.

There is also provided a deployable expandable support structure that results in a semi-rigid to rigid additional support structure for the patient transporter and for the support of a patient carried thereon.

There is further provided an expandable support structure that has two aperture joints that form three portions having a center portion between two smaller end portions, so that the expanded support structure extends about 50% of the length of the transporter when fully deployed, and provides “semi-rigid” additional support for the patient on the transporter.

The aperture joints are telescopically connected so that, prior to use, the unexpanded expandable support structure is only slightly more than one-third of the size of the fully-deployed expandable support structure. Each portion has a plurality of spaced apart cylindrical support rods or poles. The telescopic connection provides a sliding of the support rods attached to the two smaller end portions between the support rods of the center portion. The connection of the three portions is by aperture joints that have holes (apertures) therethrough to permit sliding of the support rods attached to the smaller end portions into the center portion.

There is also provided another exemplary embodiment in which the expandable support structure has at least four, and preferably five, portions that when deployed fully-expanded configuration. Specifically, this embodiment has at least two, and preferably three, center portions between two smaller end portions. The fully-deployed expandable support structure extends at least 80% of the length of the transporter to provide “rigid” additional support for the patient, head-to-toe on the transporter, directly beneath the head, torso and legs of the patient carried thereon.

The rigid support of this embodiment that has at least two, and preferably three, center sections and two end portions that are telescopically connected together so that prior to use, the expandable support structure uses slightly more than one-fourth of the space of the fully-deployed expandable support structure.

The expandable support structure is positioned in a patient transporter or litter in an unexpanded configuration prior to use, so that the transporter can be folded, stored, shipped and carried in a small size prior to deployment.

When deployed for use, the expandable support structure is pulled open inside the patient transporter to provide semi-rigid to rigid support to the transporter and to the patient carried thereon.

A cushioning material can be inserted between the patient side of the expandable support structure (opposite the backing substrate of the patient transporter) and the patient for comfort.

### BRIEF DESCRIPTION OF THE DRAWINGS

FIG. 1 is a view of the bottom side of a patient transporter having an exemplary embodiment of an expandable/deployable support structure of the present disclosure.

FIG. 2 is another view of the bottom side of the embodiment shown in FIG. 1.

FIG. 3 is a top view of an exemplary embodiment of an expandable/deployable support structure of the present disclosure in an unopened configuration for storage or carrying prior to deployment as a semi-rigid support.

FIG. 4 shows the expandable support structure of FIG. 3 in a closed configuration on the bottom side of a patient transporter of FIG. 1 before deployment as a semi-rigid support.

FIG. 5 shows the expandable support structure of FIG. 3 in an open configuration on the bottom side of the patient transporter after deployment as a semi-rigid support.

FIG. 6 is a view of the top side of the patient transporter of the present disclosure partially folded over to show a portion of the bottom side.

FIG. 7 is a schematic illustration of the bottom side of an exemplary embodiment of the patient transporter having an expandable/deployable support structure of FIG. 3.

FIG. 8 is another illustration of the bottom side of the patient transporter in FIG. 7 with anchoring straps.

FIG. 9 is a close-up of an embodiment of the expandable support structure of the present disclosure in an open (deployed) position inside the pocket on the bottom side of the patient transporter of FIG. 1, and a cord tied to the support structure that is used to pull open the support structure from outside of the pocket.

FIG. 10 is another close-up of the expandable support structure in FIG. 9 in an open (deployed) position inside the pocket on the bottom side of the patient transporter.

FIG. 11 is a close up of three individual rods of the type used in the embodiment of the expandable support structure in FIGS. 9 and 10.

FIG. 12 is a top view of another exemplary embodiment of an expandable support structure in a closed (compressed) position having three center portions and two end portions to provide rigid support of a patient transporter, and cords tied to each section for deployment.

FIG. 13 is another top view of the expandable support structure in FIG. 12 in a closed (compressed) position, with a tape measure across its width.

FIG. 14 is a top perspective view of the expandable support structure in FIGS. 12 and 13, minimally opened (i.e., partially deployed) after pulling slightly on the deploying cord, as the center portions separate from the end portion.

FIG. 15 is another top perspective view of the expandable support structure in FIG. 14, partially deployed (i.e., partially opened) after pulling somewhat harder on the deploying cord.

FIG. 16 is a top view of the expandable support structure in FIGS. 12 through 15, fully-deployed in a full open position showing three center portions and two end portions.

FIG. 17 is another top perspective view of the expandable support structure in FIGS. 12 through 16 in its fully-deployed, full open position.

FIG. 18 is a close-up of the right side view of one of the couplings of the expandable support structure in FIGS. 12 through 17 in a fully-deployed (full open) position, showing support rods that can slide through apertures in the aperture joints during deployment.

FIG. 19 is a perspective view of an embodiment of a spring lock to secure the rods of the expandable support structure in the open position after deployment.

FIG. 20 is a side view of the spring lock in FIG. 19 illustrating the release of the spring lock to block an aperture after deployment.

FIG. 21 is a right side view of the spring lock in FIG. 19, illustrating how the spring lock is attached to the aperture joint.

FIG. 22 is a perspective view of another embodiment of the expandable support structure having a web strap along each side of the support structure that allows the segments to open to their full extension at deployment, but stops the segments from being pulled out of the aperture joint.

FIG. 23A, FIG. 23B are a side view and perspective view, respectively, of a snap post on the side of an aperture joint, by which the web strap in FIG. 22 is secured to the aperture joint. FIG. 23C is a perspective view illustrating how the web strap is snapped over the snap post to secure the web strap to the side of the aperture joint.

FIG. 24 is a perspective view of an embodiment of an aperture joint in which some of the apertures have an insert that contours the shape and modifies the space in the aperture.

FIG. 25 is a perspective view of a portion of an embodiment of an expandable support structure in which the outer apertures are slightly larger than the inner apertures, so that the outer apertures can accept doubled-up rods and the inner aperture is shaped to accept a single rod.

FIG. 26 is a top perspective view of a portion of an embodiment of an expandable support structure, showing the aperture joints, rods, spring locks and pull cord prior to deployment.

FIG. 27 is another top perspective view of a portion of the expandable support structure in FIG. 26, from the opposite side, showing the three aperture joints, rods, spring locks and pull cord prior to deployment.

FIG. 28 is a top perspective view of a portion of the aperture joint in the end piece showing a rod that is fixed at one end in an aperture.

FIG. 29 is an illustration of a top view of a patient transporter showing the positions of anti-hypothermia structures, a detachable head piece, pockets, lift-and-carry handles, and patient access ports, as well as an outline indicating the expandable support structure.

FIG. 30 is an embodiment of a patient transporter of the present disclosure with a model of a patient inside, with a detachable hood on the head of the model, and with one of the anti-hypothermia covers opened at one of the patient access ports and folded over to reveal a reflective covering on the interior portion.

FIG. 31 is a view of the bottom side of an embodiment of a patient transporter having an expandable support structure of the present disclosure.

FIG. 32 is a patient transporter of the present disclosure during testing for weight-carrying capacity and strength.

### DETAILED DESCRIPTION OF THE DISCLOSURE

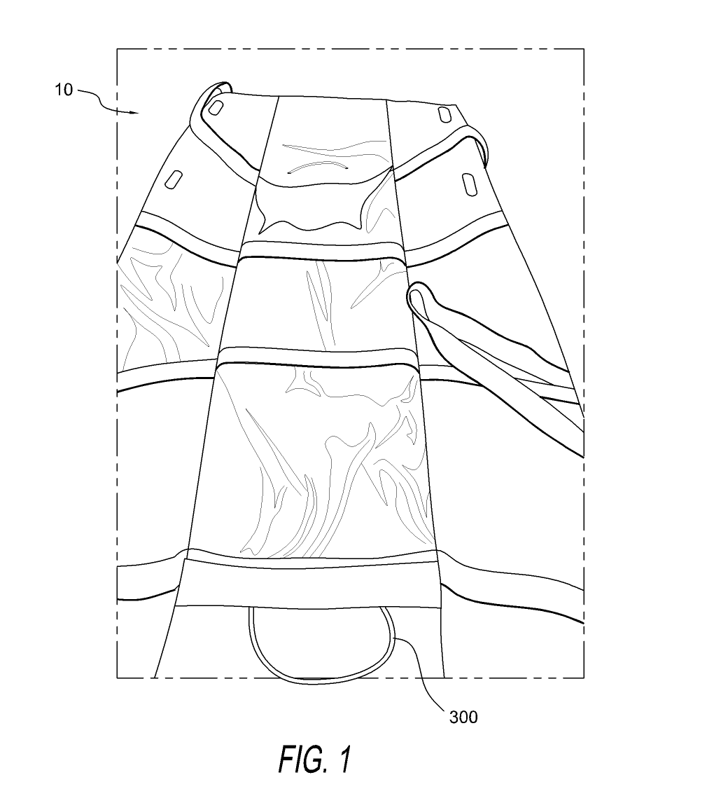

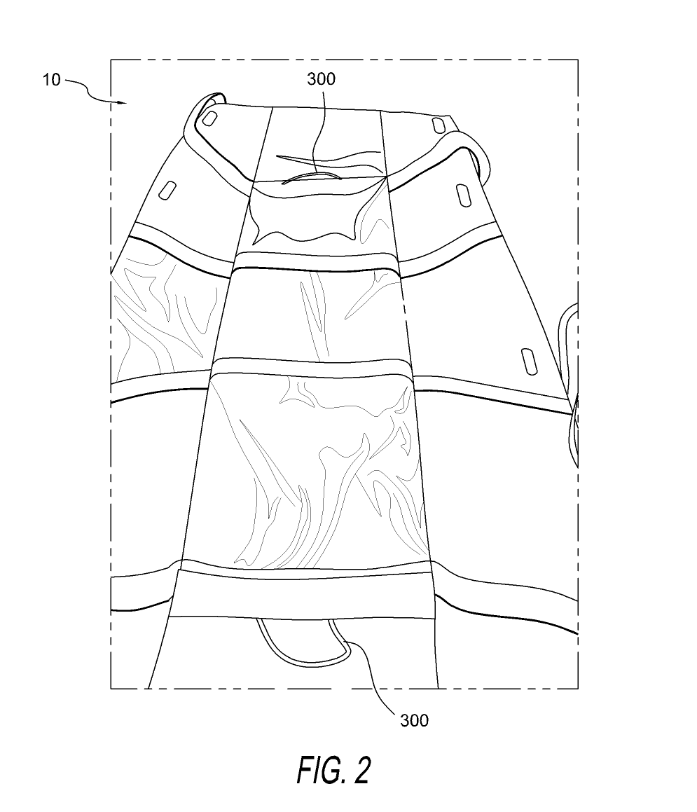

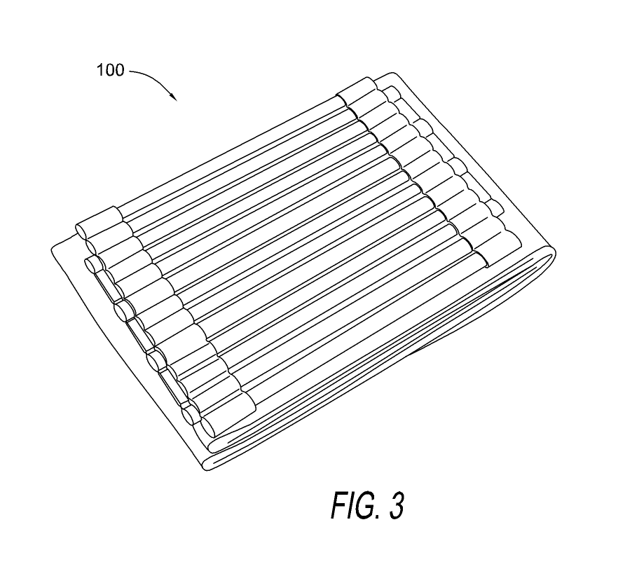

Referring to the drawings, in particular, FIGS. 1 and 2, there is provided a patient transporter generally represented by reference numeral 10 having an expandable or deployable support structure 100 shown in FIG. 3 integrated therein.

Referring to FIGS. 3 to 5, the expandable support structure 100 has three or more portions 120, 130 and 140, respectively, shown more clearly in FIG. 5, that are deployed or expanded in a fully-open configuration to provide “semi-rigid” or “rigid” additional support for the patient on the patient transporter.

As used herein, “semi-rigid” support means that the torso (or trunk) of the patient are given additional support by the expandable support structure located directly beneath those areas of the body. “Rigid” support means that the torso and the lower extremities are given additional support by the expandable support structure located directly beneath.

In a first exemplary embodiment, the expandable support structure has a center portion 130 between two smaller end portions 120, 140, or three total portions, to provide “semi-rigid” additional support for the patient on the transporter.

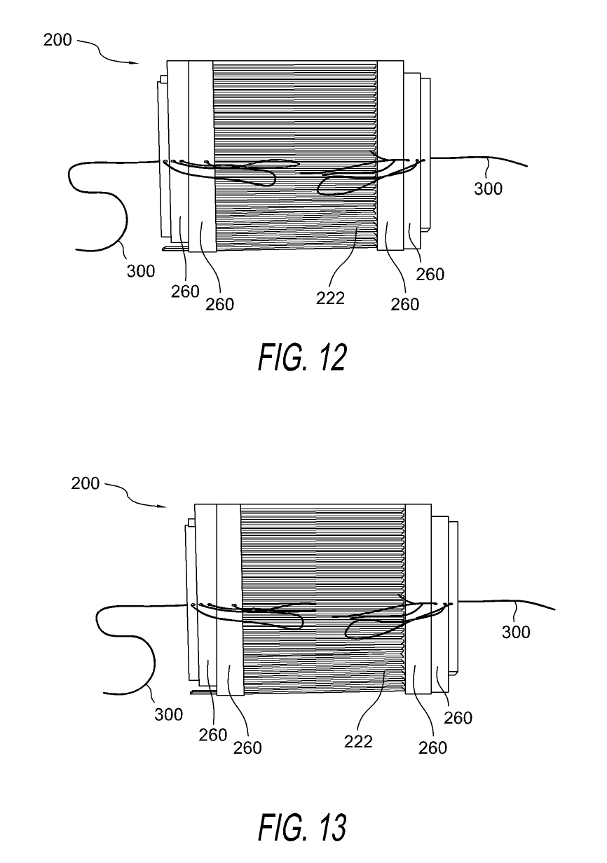

In another exemplary embodiment shown in FIGS. 12 to 18, this expandable support structure 200 has two or more, preferably three, center portions 230, 250, 270 between two smaller end portions 220, 240 to provide rigid additional support for the patient on the transporter.

When deployed, a “semi-rigid” support structure 100 extends longitudinally about 30-70% of the total length of the transporter. In a preferred embodiment of the transporter, the semi-rigid support structure 100 extends longitudinally about 50% of the total length of the transporter. A “rigid” support structure 200 can extend longitudinally to cover 70% or more, and preferably extends 90% or more of the length of the transporter 10. In a preferred embodiment of the transporter 10, the rigid support structure 200 extends 90-96% of the total length of the transporter.

The portions of the expandable support structure are connected by a telescopic connection that is called herein aperture joints 160, 260. “Aperture joints” may also be called “knuckles” or “contoured aperture joints” interchangeably. Each portion 120, 130 and 140 of structure 100, and center portions 230, 250, 270 and end portions 220, 240 of structure 200, are composed of a plurality of spaced apart cylindrical rods or poles. The poles of the smaller end portions slide into spaces between the poles in the center portion or portions as discussed below. The aperture joints 160, 260 have apertures sized therein that permit the sliding of the poles of the smaller end portions therethrough. In the first embodiment support structure 100, the center portion 130 has the two aperture joints 160 at its end. The end portions 120, 140 have poles 122, 142, that slide through the apertures of the apertures joint 160. The free ends of the end portions 120,140 have an end piece 126, 146, respectively, to hold the poles in place.

In the first (semi-rigid) embodiment above, the expandable support structure 100 has three portions 120, 130 and 140 that are telescopically connected together. In a closed configuration, the support structure 100 occupies just slightly more than one-third of the space of the fully-deployed or expanded support structure.

In the second (rigid) embodiment above, the expandable support structure 200 has five portions that are telescopically connected together. In a closed configuration, the preferred support structure 200 that has five portions occupies just slightly more than one-fifth of the space of the fully-deployed or expanded support structure.

Before deployment, the expandable support structure 100, 200 is in a closed (or collapsed) configuration, thereby permitting the patient transporter to be easily folded about the support structure to a small size for ease of storage and shipping, and for easier carrying to the site where needed. Deploying the support structure for use provides additional rigidity and support under the patient's torso (semi-rigid) and/or the patient's torso and/or legs and/or head (for rigid).

The expandable support structure 100, 200 of the present disclosure could be integrated, namely made a fixed or removably part thereof, into the underside of any patient transporter or stretcher, including, but not limited to, a patient transporter having features in: U.S. Patent Application Publication No. US 2010/0199435, “Lightweight Absorbent Transporter”; U.S. Patent Application Publication No. US 2010/011506, “Disposable Transporter”; and/or U.S. Patent Application Publication No. US 2012/0284923, “Patient Transporter with Inflatable Chambers.” The features of these patient transporters are further described below. In a preferred embodiment, the expandable/deployable support structure is used in a patient transporter having anti-hypothermia features. Another embodiment is a patient transporter designed for Level I hypothermia transport.

The expandable support structure is deployed by pulling on the two end portions outwardly, in the direction away from the center portion(s). This can be done by pulling on an extension pull, such as a cord 300 (also called “pull cord” herein) that is tied to the end portions of the support structure. The outward force can be applied by hand, or by any other means that pulls the end portions away from the center portion(s) of the support structure.

Referring to FIG. 1 and FIG. 2, an exemplary embodiment of the patient transporter 10 having an expandable support structure 100 or 200 shown in FIG. 3 or FIG. 12, respectively, integrated on the underside is shown. In this embodiment, the support structure 100, 200 is covered by an outer cover layer that forms a pocket on the underside of the transporter that has room for the support structure to expand when deployed. As shown, a loop of cord 300 (which is tied to the smaller end portion on both sides) protrudes from each end of the pocket, which is used to deploy the support device. The outer cover layer also provides a finished appearance to the transporter.

The patient transporter 10 can have a web strapping material attached to the underside of the pad, as shown in FIGS. 1 and 2, to facilitate carrying the transporter and to provide additional carrying strength.

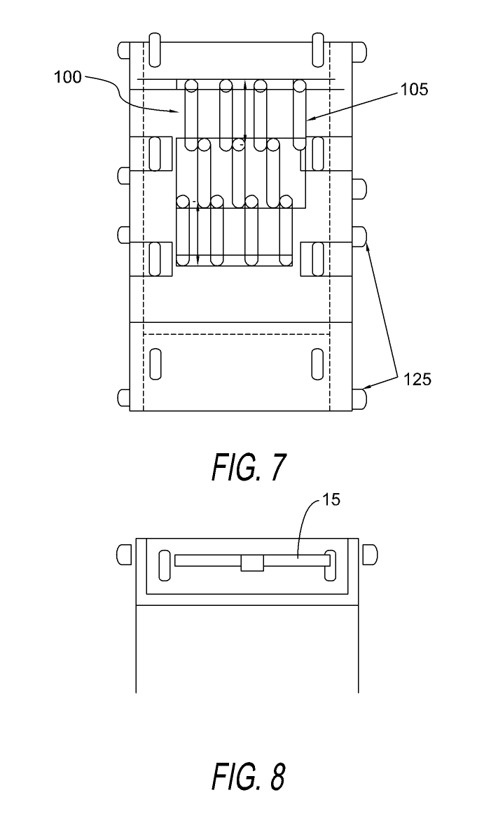

The patient transporter 10 can also have one or more straps or links positioned along the periphery, which can be used as handholds to carry the transporter, and/or provide an attachment site for a shoulder strap to ease carrying or, if necessary, to drag the transporter. As shown in FIGS. 1 and 2, and illustrated later in FIG. 7, several “D”-link connection points are shown around the periphery of the transporter, which can be used to attach a shoulder strap.

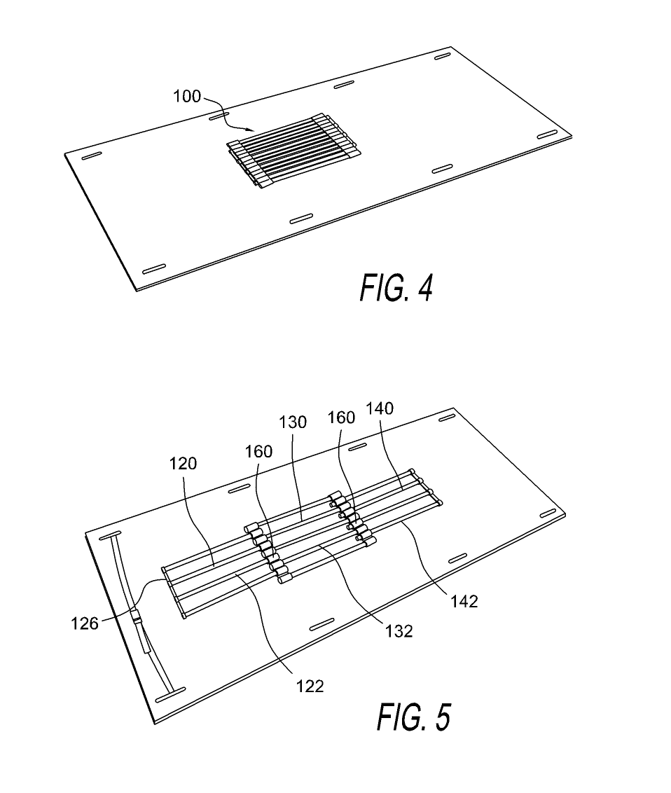

In FIG. 3, an exemplary embodiment of a semi-rigid expandable support structure 100 (also called a support device in this disclosure with no change in meaning), is shown in a closed configuration. The support structure 100 has a center portion 130 and two smaller end portions 120, 140. These smaller end portions mean that these end portions have a small number of rods or poles. In this embodiment, the rods or poles are wooden dowels. Since the support structure 100 in FIGS. 1 and 2 is covered by an outer covering layer and not readily visible, FIG. 4 is provided to illustrate how the support structure 100 is positioned on the underside of the patient transporter 10. The center portion of the support structure 100 is secured to the underside of the transporter 10. FIG. 5 shows the semi-rigid support structure 100 in its fully-deployed (full open) configuration. Again, in many embodiments, the support structure 100 would not be visible on the underside of the transporter 10, as in FIGS. 4 and 5, but rather would be covered by an additional outer layer that secures the support structure and provides a finished appearance.

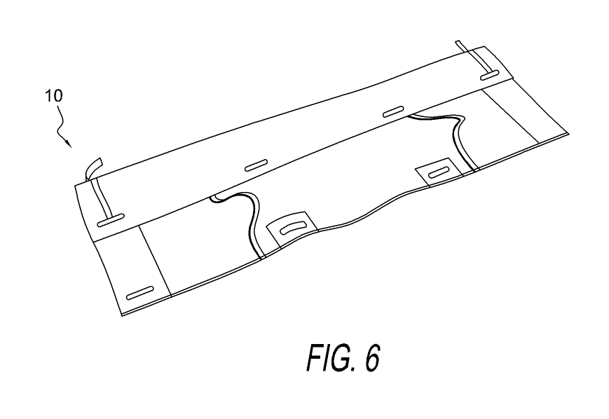

FIG. 6 shows the top side of a patient transporter 10 of the present disclosure that is partially folded over longitudinally to show a portion of the underside. The light-colored area on the top side is an absorbent material that absorbs liquids, such as blood and other body fluids from the patient, and/or any medical fluids (saline, betadine) that are being used to treat the patient. The absorbent material keeps the patient dry and reduces the risk of infection to the persons carrying the transporter and to the patient himself.

FIG. 7 illustrates a deployed expandable support structure 100. Support rods 105 are part of an expandable support structure assembly that slides together prior to deployment to reduce the size of the support structure, and slide apart when the expandable support structure is deployed. Four (4) b-links 125 are located along each side of the transporter in FIG. 7, which can be connected to shoulder carrying straps to assist carting of the patient transporter with a person thereon, as described further below.

FIG. 8 shows the bottom side of patient transporter 10 having one or more anchoring straps 15 that can be used to secure the patient transporter to a rescue vehicle, including a helicopter, truck or car.

For patient comfort, a cushion layer (not shown) can be positioned between the expandable support device and the patient. In certain embodiments, the cushion layer is integrated entirely in the structure of the transporter; alternatively, the cushion layer may be separate from the transporter and freely positioned under the patient's body. The cushion layer can be made of a soft foam or similar material.

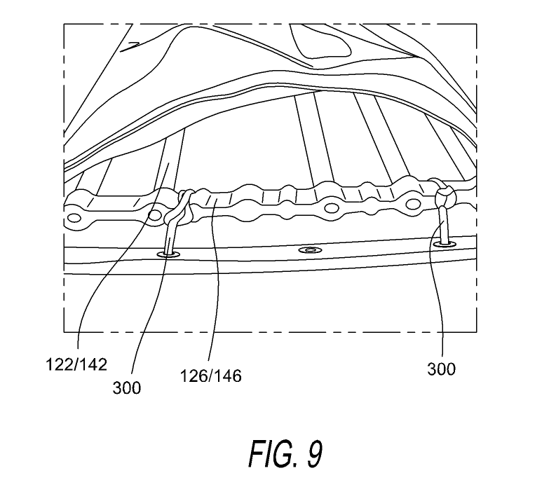

As shown in FIG. 9, the end portions (also called end sections with no change of meaning in this application) have a loop of cord 300 attached at two places, to apply an outward force that will deploy (open) the support device 100.

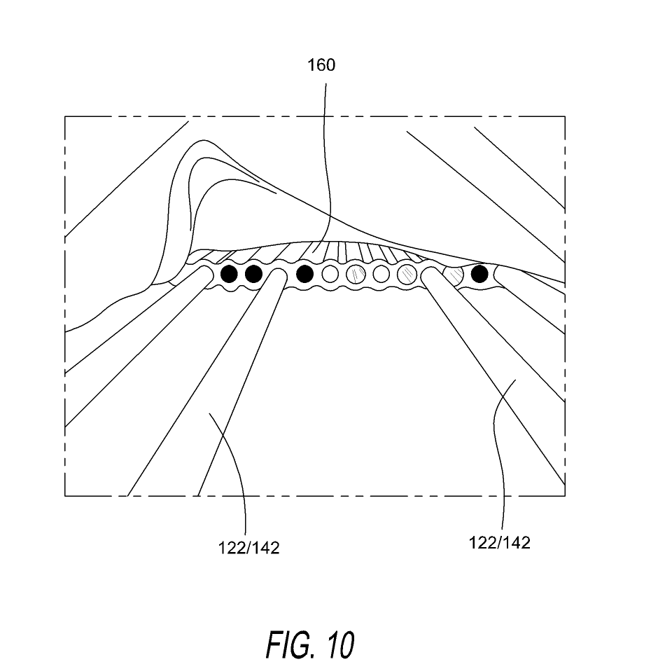

When the force is applied to the cord, the support rods 122, 142 of the two end portions slide through the apertures in the aperture joint or knuckle 160, as shown in FIG. 10. FIG. 10 shows that, when the center and end portions are closed, supporting rods 122, 142 slide through aperture joint 160.

To deploy the support device 100, the cord 300 is pulled outwardly, causing the support rods 122, 142 that are attached to the end portions 120, 140 to slide through the apertures in aperture joint 160, to open the support device to full extension. Once in the full open (deployed) configuration, the support rods snap (or lock) in position in the aperture joint 160 to provide greater support, and to prevent the support rods 122, 142 from sliding back through the apertures. For a single-use (disposable) patient transporter, this locking of the support rods provides additional support and prevents unintentional closing of the support structure. However, where it is desirable that the support structure be re-closed after deployment (for example, to reduce space for disposal of the transporter after use, or to permit re-use of the transporter), the support rods can be shifted to permit the support device to be re-closed after use.

The cord 300 itself can act as an extension stop (also called a “hard stop”) when the support device 100, 200 achieves full extension. Alternatively, the support rods 122, 142 can be tapered so that they slide through the apertures to a certain point but do not pull all the way through the couplings to fall out. Other options for an extension stop include, but are not limited to, pins or overmolded plastic ends (i.e., flattening the ends), so that the support rods slide out to a certain point but do not pull out of the coupling.

To keep the cord 300 from falling between the rods when the support structure is deployed, nylon fabric can be added between the portions or sections. The nylon fabric also permits the portions of the support structure to be closed up again without the cords getting in the way.

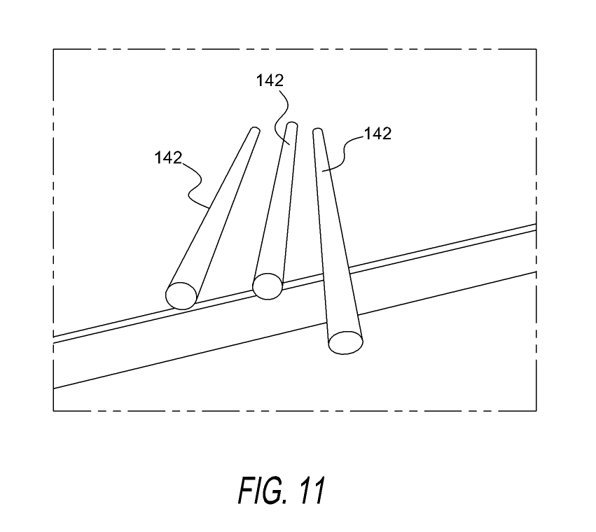

As used herein, the support rods 122, 132, 142 can be any shape, including cross-sections that are round, ovate, flat, square, or rectangular (bars). A preferred embodiment uses round support rods for ease of slidability. The support rods can be solid, for greater strength, or partially or completely hollow, to reduce weight. The support rods can be made of wood, metal, fiberglass, carbon fiber, polymers, and/or plastic materials that can be selected based on factors that include, but are not limited to, strength, weight, as well as tensile and flexural properties. FIG. 11 shows an embodiment of three support rods 142 made of plastic, and having a generally round cross-section.

Carbon fiber support rods have the advantage of being very lightweight and strong, but are more expensive than other materials that can be used for support rods, and so carbon fiber rods are preferred for patient transporters where weight is such an important factor that it overrides cost considerations. Fiberglass support rods, by comparison, are a little heavier and much less expensive than carbon fiber support rods, and so fiberglass support rods can be selected for expandable support structures where cost is a more significant factor.

To increase strength of the expandable support structure, the outside support rods can be “doubled-up” by using an outer aperture shape that is larger and shaped to receive a doubled-up support rod. The inside support rods are preferably single rods, and the corresponding apertures are smaller (one way of achieving this is by using inserts inside the apertures, described below), and shaped to receive a single support rod.

The gaps between the slidable support rods provide a comfortable support of the patient's weight, and a degree of flexibility and slight deflection from horizontal that a conventional support (such as a wood board) does not provide to the patient. The support rods provide additional support and comfort to the patient.

As shown in FIGS. 12 and 13, an embodiment of an expandable support structure 200 for “rigid” support is provided having three center portions and two end portions in a closed configuration. Cords 300 are attached to the aperture joints 260 so that the support structure 200 can be deployed. In this embodiment, the support rods 222 are rectangular bars (i.e., have a rectangular cross-section). It should be understood that the sliding support rods of the end portions into center portions and the sliding into the centermost portion is the same mechanism of action as present in the first embodiment of expandable support structure 100, except that this embodiment of expandable support structure 200 has three center portions, rather than one.

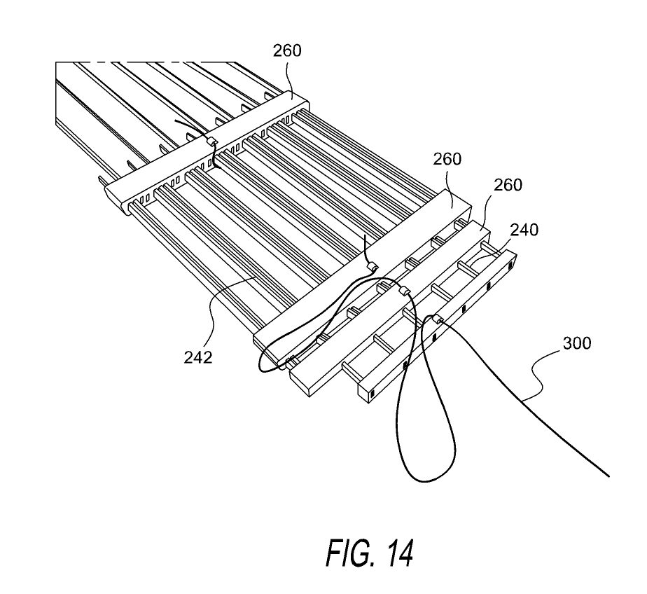

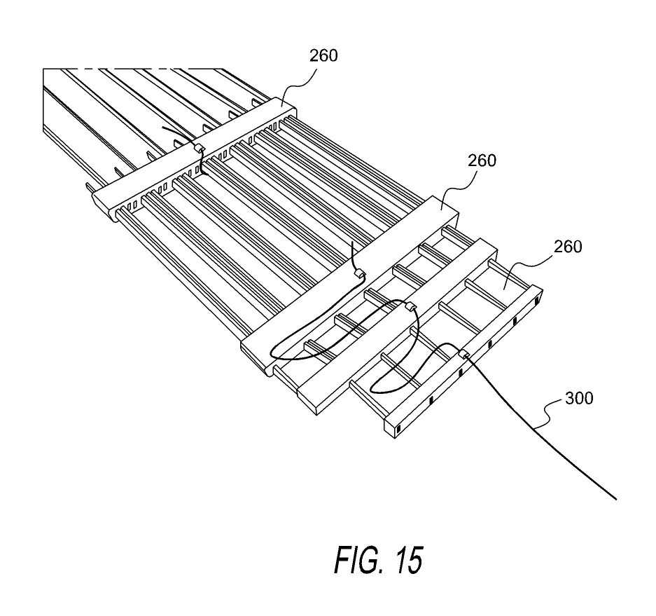

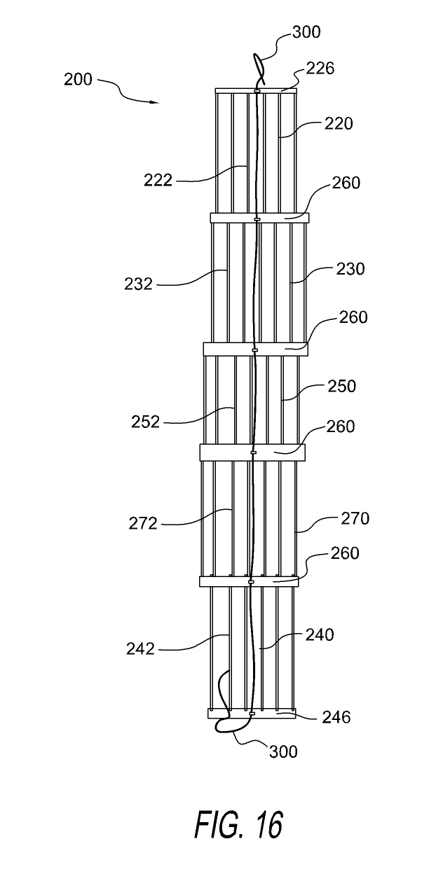

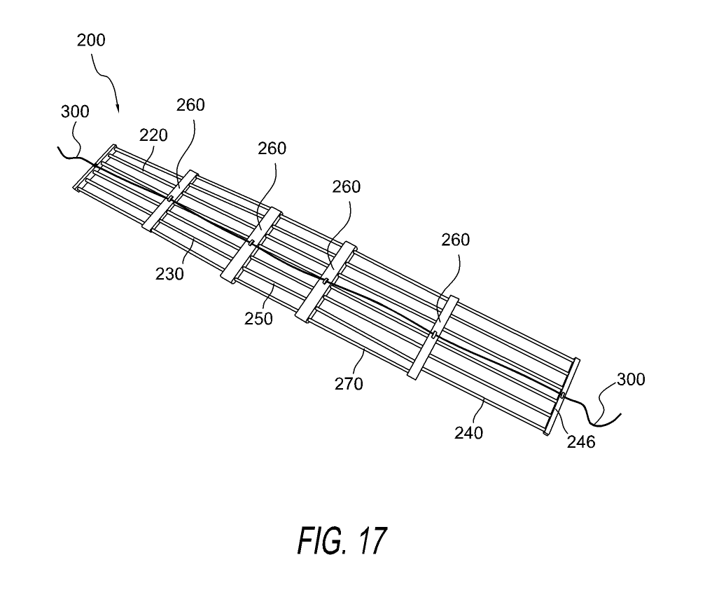

FIGS. 14 and 15 illustrate deployment of the support structure 200 by pulling on the cord 300 in an outward direction away from the center portion. As the coupling portions are separated from each other and move outwardly, the support rods attached to each portion slide through the apertures in the aperture joints 260 and gradually open the support device. When the end portions 220, 240 reach the extension stops, the support structure 200 is fully deployed, as in FIGS. 16 and 17. In this “rigid” embodiment, the support structure 200 once integrated in the patient transporter would extend longitudinally for nearly the entire length of the transporter, providing additional support directly beneath the patient from his upper torso and head/neck to the bottom of his legs.

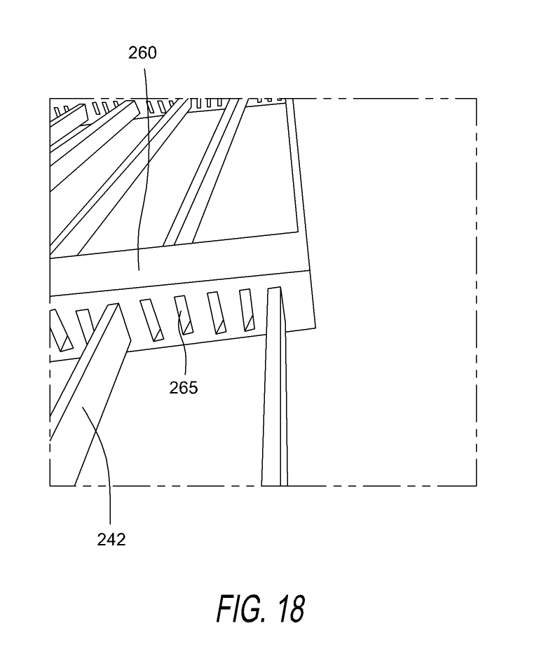

FIG. 18 is a close-up showing apertures 265 in aperture joint 260, with carbon fiber support rods 242 that slide easily through the apertures to expand the support structure 200 until reaching an extension stop. The “centermost” center portion has a pair of aperture joints 260, while each of the other two center portions has one aperture joint.

The center portion of the expandable support device can be secured to the underside of the patient transporter. This keeps the center portion in the middle of the transporter, and provides some resistance so that pulling on the end sections will open the support structure. Alternatively, the support structure can be unsecured but sandwiched in a pocket formed between two layers, usually of nylon or other outer covering material, on the underside of the transporter that provides space for the support structure to expand longitudinally.

By using a support structure, the carrying force to lift and carry the transporter is distributed across the support structure, rather than to the patient, increasing patient comfort.

Another exemplary embodiment is a portable/disposable litter having rigid support and anti-hypothermia features. The litter is constructed with a highly absorbent cellulose core and possesses the ability to contain blood and body fluids for safe transport. The absorbent core holds fluids and retains solutions including, but not limited to, saline, betadine, sterilants, blood and body fluids. The litter has a fluid absorption barrier that further promotes the safety, cleanliness, and infection control relating to transport of a patient on the litter and on evacuation vehicle floors. The litter is designed with a deployable support structure built into the litter, which permits a more rigid support under the patient to aid stability during transport of the patient.

The litter is designed to be used during transport and evacuation situations by itself or, alternatively, as a complete cover for stretchers/litters. The litter has anti-hypothermia properties for warmth and to preserve the patient's body temperature.

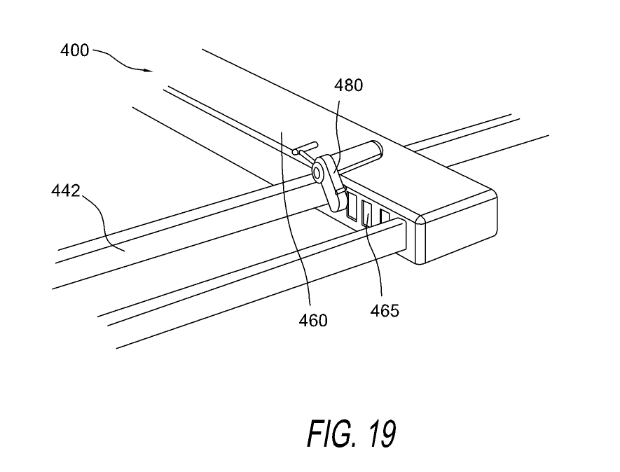

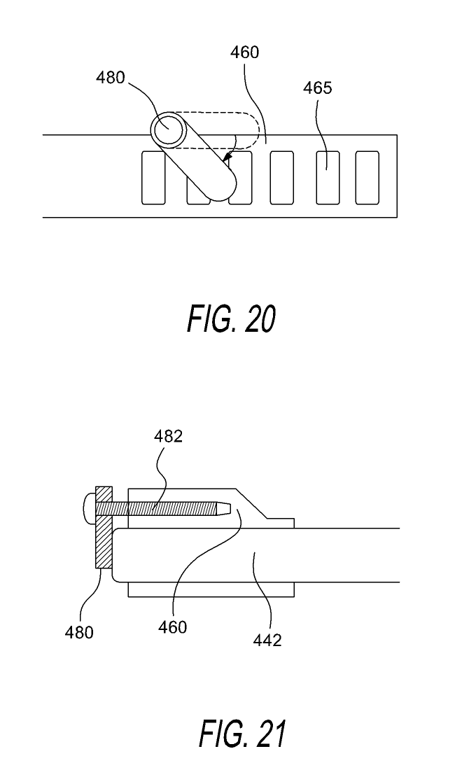

FIG. 19 illustrates an exemplary embodiment of a portion of expandable support structure 400, in which one or more lock 480 that is tension-loaded, preferentially by a spring (and so is called “spring lock” interchangeably herein), is connected to the top and/or bottom side of aperture joint 440 (in the embodiment in FIG. 19, lock 480 is shown on the top side of aperture joint 460). Prior to deployment of the expandable support structure, lock 480 is held in a first, non-blocking position against support rod 442 in high tension. After the expandable support structure is deployed, causing support rods 442 to slide through their corresponding apertures 465 of aperture joint 460 to full extension, lock 480 releases to a second position under slight tension so that the arm (also called the “latch tab”) of lock 480 partially or completely blocks aperture 465, thereby preventing support rod 442 from sliding back to its former (collapsed) position. Each lock 480 ensures that the corresponding support rod 442 is maintained in a fully-extended, locked position after deployment. The mechanism of action of lock 480 is shown more clearly in the detail view in FIG. 20. Once released in this way, lock 480 prevents the expandable support structure from collapsing back to its smaller size after deployment, so that the expandable support structure remains securely “locked” in its fully-extended position and cannot collapse to its smaller size while a patient is being carried on the patient transporter. Lock 480 can be secured to aperture joint 460 as shown in FIG. 21 by a simple screw assembly 482 into plastic bosses that can be molded in line with the body of aperture joint 460, or secured thereto by a fastener, such as by an another screw or by an adhesive. There may be one or more locks 480 (and preferably two) per section of the expandable support structure. The latch tab may be a lasered or punched metal. The spring is preferably, but not limited to, a stainless steel torsion spring.

Lock 480 is only one way to lock the expandable support structure in its fully-extended position once deployed. Alternatively, a piece of fabric could be used instead of lock 480, where the fabric is bunched to one side (in between two support rods), and, as the support rod passes through, the fabric expands to form a block over the aperture, thereby preventing the support rod from passing back through. Another embodiment uses a plastic slide hinge, similar to lock 480 above, but fabricated from plastic or similar material to block the aperture. Still another embodiment uses a ball bearing fabricated into cavities within the aperture joints that engage into a similar cavity machined into the support rods. The ball bearing is depressed when the expandable support structure is collapsed and the rod is against it (i.e., prior to deployment), and then springing out as the support rod moves past it and the cavity, within the support rod, is exposed.

In some instances, lock 480 can be engineered to deliberately permit “unlocking” the expandable support structure after deployment, so that the expandable support structure can be collapsed to its original smaller size for re-use and re-arming lock 480 under high tension. The bias that causes lock 480 to close to block aperture 465 can be overcome by applying an external force. This may be desirable, for example, in those instances where a particular patient transporter was deployed but not used, or, as part of a program to re-use the expandable support structure in a new patient transporter after removal from the old patient transporter; in effect, to retain the hard goods (e.g., the expandable support structure) and dispose of the soft goods (the remainder of the patient transporter) after use.

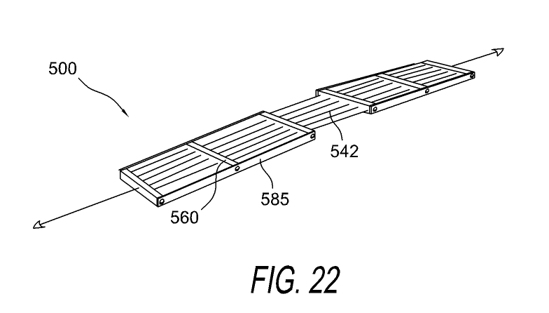

FIG. 22 illustrates an embodiment of an expandable support structure 500 having three aperture joints 560 that are telescopically connected by the plurality of support rods 542 to form five sections of the expandable support structure. When deployed (as shown in FIG. 22) in a patient transporter (not shown), the expandable support structure provides rigidity and support directly beneath a patient's torso, head and legs. Web straps 585 are connected along each side of expandable support structure 500 as a stopper that prevents the plurality of support rods 542 from pulling out of aperture joints 560. Web straps 585 can be any type of web material, including, but not limited to, nylon binding. In an exemplary embodiment, each web strap 585 is a ¾″ nylon binding that extends the length of expandable support structure 500.

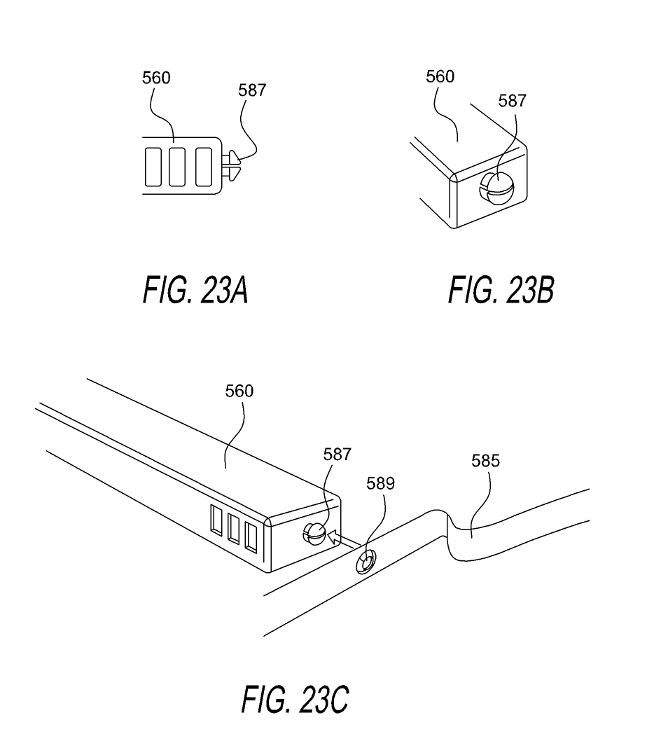

FIG. 23A and FIG. 23B illustrate a snap post 587 that can be used to readily secure web straps 585 to the outer ends of aperture joints 560. Web strap 585 can have a hole with a metal grommet 589 that can be snapped over snap post 587 to secure the web strap to the expandable support structure.

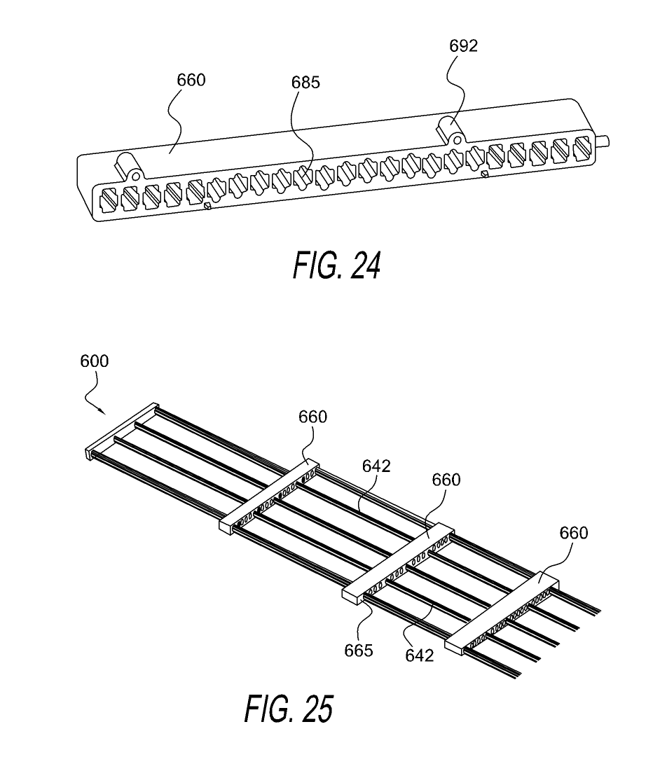

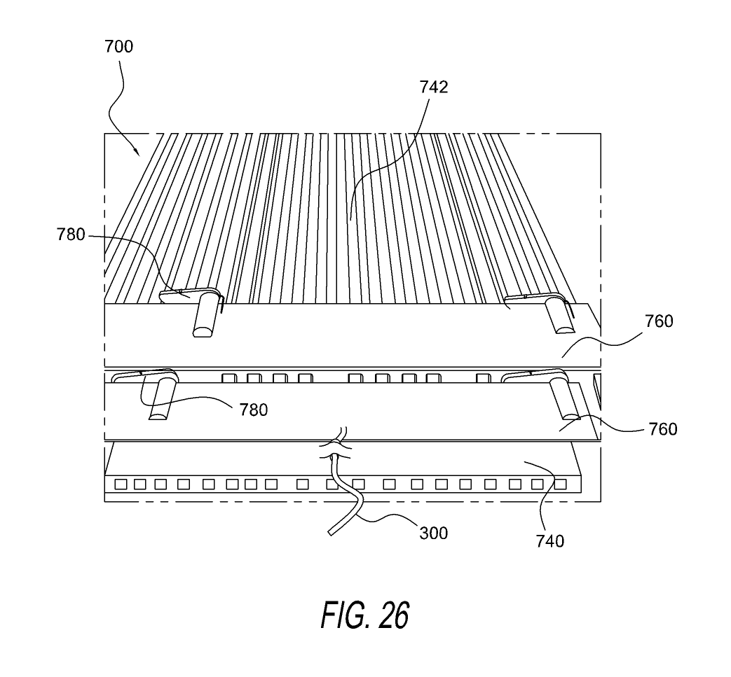

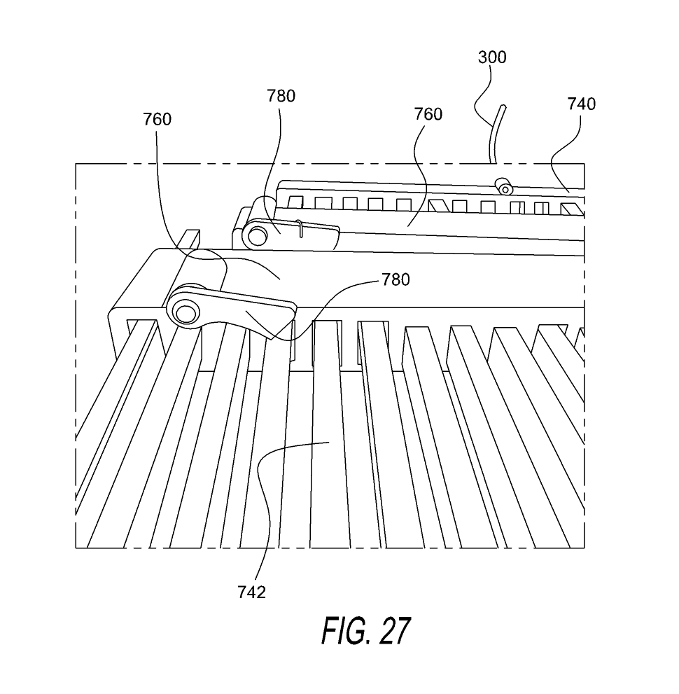

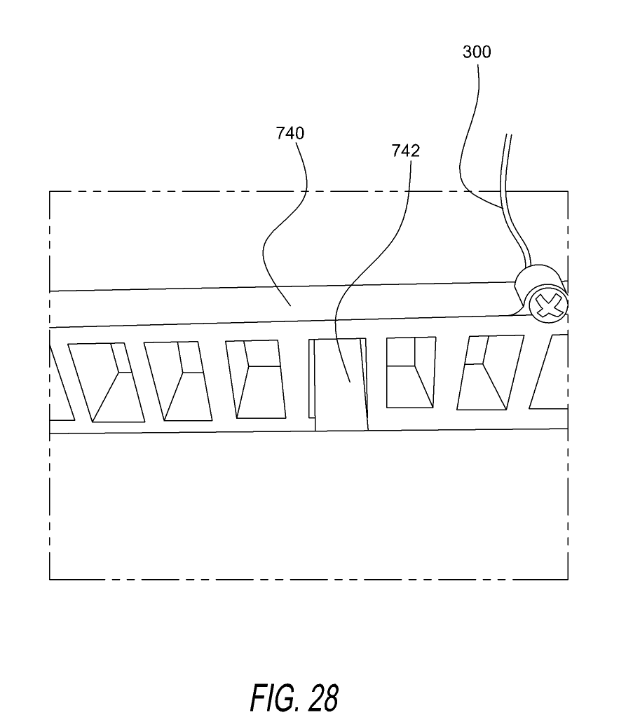

FIG. 24 shows an embodiment of an aperture joint 660, having a plurality of apertures 685 that extend in a single longitudinal row. Two bosses 692 where a lock under tension can be received (not shown in FIG. 24, but shown in FIGS. 19 to 21 above, and in FIGS. 26 and 27 to follow). In this embodiment, aperture joint 660 is a single molded structure. As a manufacturing option, a single die can be used to manufacture an aperture joint that can accommodate support rods of different diameters and materials. An insert can be used in some or all of the apertures to modify the size and shape of the aperture so that support rods slide through without wobble. A draft (taper) can be added to modify the shape of the aperture opening and/or insert openings to reduce friction, so that the support rods slide through the aperture joints almost frictionlessly during deployment.

FIG. 25 shows a portion of expandable support structure 600, with aperture joints 660, and support rods 642. Outer support rods in FIG. 25 are “doubled-up,” and so the corresponding outer apertures 665 have openings that are larger and are shaped to receive doubled-up support rods. The inner support rods in FIG. 25 are single support rods, and so the corresponding apertures are smaller by inserts inside the apertures and are shaped to receive a single support rod.

FIGS. 26 and 27 show two views of the same portion of an exemplary embodiment of an expandable support structure 700, having a plurality of support rods 742, two aperture joints 760, an end piece 740 with a pull cord 300, and two spring locks 780 on each aperture joint held against the support rods in high tension in the first (non-blocking) position.

FIG. 28 shows a close up of end piece 740 and pull cord 300, with a support rods 742 affixed to the end piece.

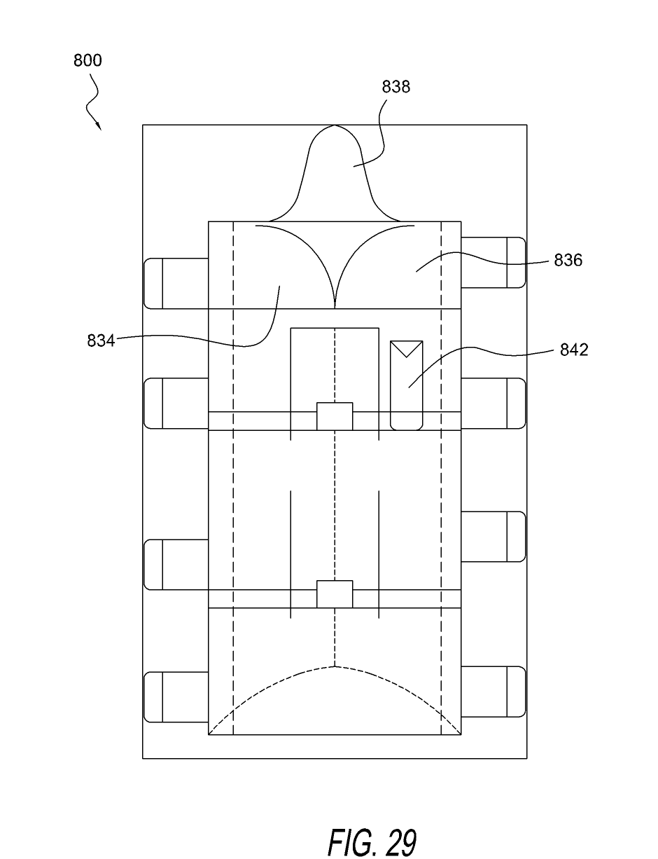

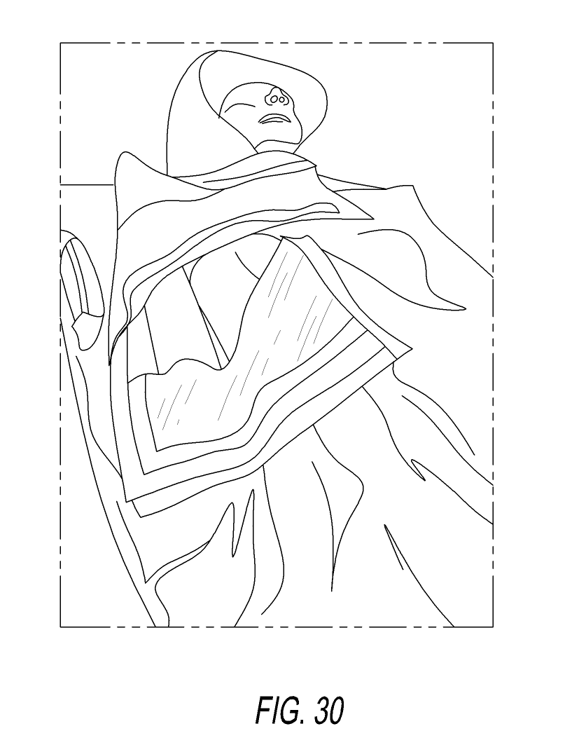

FIG. 29 is an illustration of an embodiment of a patient transporter 800 showing anti-hypothermia structures 834, 836, detachable head piece 838, and an external pocket 842, described below. D-links (not shown in FIG. 29) may be provided at the top corner (i.e., at the head) of patient transporter 800. When combined with a shoulder strap (not shown), the D-links assist in carting of the patient transporter and patient. The length and width of the strap should be sufficient to permit even one person to put the strap over his shoulder and cart the entire patient transporter and patient if necessary in an emergency. A non-limiting example of a strap length is 3.5 feet in length. Lift-and-carry handles (not shown in FIG. 29) may also be provided at the top and bottom of transporter 800 to assist this carting. Padding/cushioning material can beaded to cover the entire length of the expandable support structure (when deployed) and positioned above the expandable support structure but below the patient and below an absorbent body positioned beneath the back portion of the patient.

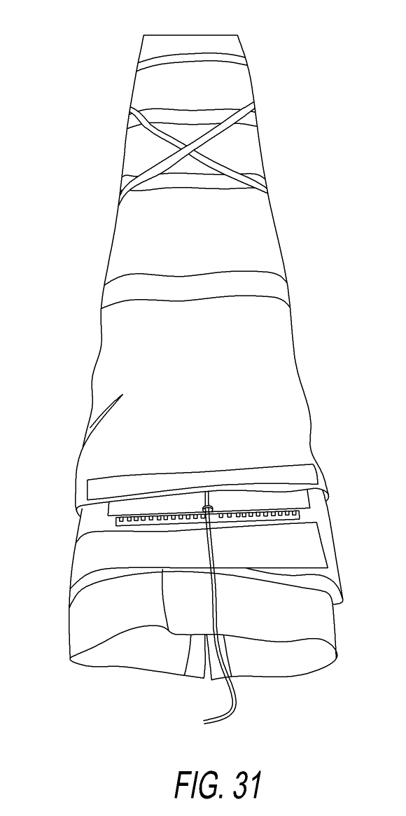

FIGS. 30 and 31 illustrate an exemplary embodiment of the present disclosure that is an Absorbent Patient Litter System (APLS) Rigid Mylar Thermal Guard (Paper-Pak Industries, LaVerne, Calif., APLSV-2276-2R—vacuum pack). The finished product dimensions are about 22″×76″ (55.88 cm×193.04 cm), and thickness of about 0.7250″ (1.84 cm). The product weight is about 7.0 pounds (3.18 kg) dry weight. The product has a weight capacity of carrying up to about 320 to about 350 pounds (145.15-158.76 kg), wet or dry. The target absorbency is about 1500-1850 grams (1.7 liters) of absorbed liquids including water, blood and/or body fluids, with a preferred absorbency of 1700 grams. The absorbent core absorbs and contains any absorbed liquids, and can be easily disposed after use.

The above APLS-Rigid Mylar Thermal Guard product is made with a closed edge format, and is constructed with durable outer materials and a core of composite material with one side having a porous strong cover stock material that is a nonwoven. The product is adhesively bonded to allow for combined construction. The top assembly is a combination of a durable outer layer and a reflective inner layer to help maintain body heat, as shown in FIG. 30. Material sewing at carrying points provides reinforcement. The product has a leak-proof backing for additional strength even while dragging along the ground. The product has 8 lifting straps to allow for carrying and easy transport. The product is lightweight but strong. For storage, the product is compressed and vacuum packed. The product has pockets for medical papers, personal effects, medical records and films (such as x-rays), and CD-ROMs, as illustrated in FIG. 29. The product can have a detachable hood, as also illustrated in FIG. 29, to protect the patient's head and reduce loss of body heat through the head and neck. There are eight (8) patient access points for treating the point of injury without opening the entire cover, as shown in FIG. 30. Also, an expandable, deployable support structure is in the product, as shown in FIG. 31.

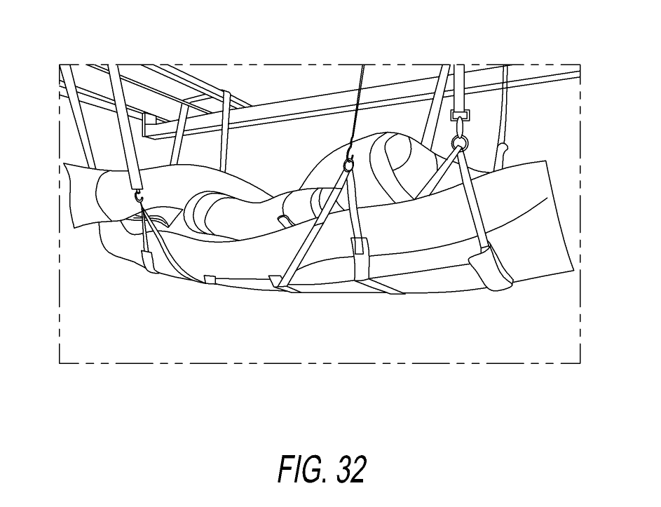

The patient transporter of the present disclosure with the expandable support structure deployed has excellent overall strength. As shown in FIG. 32, when a patient transporter with the expandable support structure was loaded with 515 pounds of weight, the patient transporter was able to support this large weight with little deflection from horizontal.

As noted above, the expandable support structure can be used to provide additional support and rigidity in portable, lightweight patient transporters, such as the exemplary embodiments of patient transporters below.

An exemplary embodiment of a patient transporter has a backing substrate that forms part or the entire back portion of the patient transporter. The backing substrate preferably covers the entire back surface of the patient transporter. In some embodiments, the backing substrate can be folded at the top and bottom edges of the transporter to form a top edge and bottom edge, respectively, of the transporter. The backing substrate can be secured in position by thread, adhesive, or interlocking material such as VELCRO® (Velcro Industries B.V. LLC Netherlands, Curacao, Netherlands Antilles), and is preferably adhered to the top of the transporter by sewing across the width of the transporter. When folded over the top or bottom edges of the transporter, the backing substrate can extend a distance of at least one (1) inch to about one-quarter of the total length of the transporter. For example, for an embodiment of a patient transporter having an outer lengthwise dimension of seventy-eight inches (78″) (198.1 cm), the backing substrate could be folded over each of the top and bottom edges to extend an additional length of about 19.5 inches inward from the top and bottom edges, respectively.

The backing substrate can be made of material that includes, but is not limited to, nylon, nylon composite material, strong cloth material, canvas, hemp, flax, cotton fiber materials, polyethylene, polypropylene, polymer films, or any combinations thereof. A preferred embodiment of the backing substrate is made of nylon material. Another embodiment of the backing substrate is made of cotton or canvas material. Still another embodiment of the backing substrate is made of polyethylene and/or polypropylene films.

The backing substrate provides durability, strength, weather-resistance, and ruggedness to the patient transporter. The backing substrate is preferably made of material that is puncture-resistant. Puncture resistance is particularly useful for those embodiments likely to be used to carry an injured person over rugged terrain or rough surfaces, especially where a single person is effecting a rescue and carry, and must pull the transporter and the person over the terrain. The backing substrate can also provide a wind barrier and moisture barrier that protects and secures the patient.

The backing substrate can be of any color and/or patterns that facilitate military and civilian applications. Examples of colors and/or patterns include, but are not limited to, black, white, khaki, and/or camouflage.

In other exemplary embodiments, the patient transporter further includes an absorbent body, as in the Absorbent Patient Litter System (APLS) embodiment disclosed above.

The absorbent body can be connected to the top surface of the backing substrate to absorb large amounts of body fluids, such as blood or urine that may be exuded from the patient, as well as liquids from any other source that may contact the portion of the transporter next to the patient. The absorbent body is typically sized less than the backing substrate, so that a portion of the backing substrate forms an edge about a portion of the absorbent body.

As used herein, a “large amount” of body fluids or liquids is an amount of fluid or liquid greater than one-half liter (0.5 L) of fluids. In an exemplary embodiment of the absorbent body, the “large amount” of body fluids that can be absorbed in the absorbent body is about four-and-a-half liters (4.5 L) of liquid.

Absorbency of body fluids or other liquids by the absorbent body depends on the overall size and structure (e.g., numbers of layers and types of absorbent material used in each layer) of the absorbent body. Typically, the absorbent body absorbs about 1.70 to about 1.75 grams of body fluids liquids per square inch of absorbent material. Absorbency can further be adjusted to a higher or lower level simply by changing to a higher-performance or lower-performance absorbent material or structure.

When the patient is placed on the absorbent body on the transporter, the absorbent body typically contacts only the back portion of the person carried thereon to absorb any exuded body fluids, and thereby acts to dry the patient and keeps him comfortable during transport, and also reduces the risk of contamination to litter carriers and medical personnel.

The absorbent body can be permanently connected to the backing substrate, or can be a separate piece that is removably connected to the backing substrate, thereby permitting the absorbent body to be removed after use and replaced with another (unused) absorbent body. The absorbent body can be removably connected to the backing substrate by an adhesive material, either on the absorbent body or on the backing substrate, where the adhesive material includes, but is not limited to, glue, two-sided tape, thread, and/or a hook-and-loop interlocking device such as VELCRO®.

The absorbent body can have one or more layers of absorbent or superabsorbent material. The one or more layers can be adjacent to each other, bonded together, or formed into a composite structure. Examples of absorbent or superabsorbent material that can be used for the absorbent body include, but are not limited to, cellulose, cellulose fiber, fluff pulp, airlaid material, nonwoven, airlaid nonwoven, a superabsorbent polymer (SAP), SAP composite, thermoplastic polymer fibers, airlaid SAP, a fibrous or foam structure coated with SAP, starch-based superabsorbents, such as BioSAP™ (Archer Daniels Midland, Decatur, Ill.), or any combinations thereof. The absorbent material may be treated or coated with a surfactant to regulate uptake and strikethough of fluids, or to direct absorption to another portion or zone of the absorbent body away from the patient.

The absorbent body may also contain, or be treated with, a surfactant, to enhance absorption of fluids by the absorbent body. Examples of surfactants that can be used in the present disclosure include anionic surfactants, cationic surfactants, zwitterionic surfactants, and non-ionic surfactants.

The absorbent body may have one or more strengthening layers to improve strength and/or resistance to tearing. The one or more strengthening layers can be located on top of, below, or in between any portion of the absorbent body. A strengthening layer for the absorbent body may be made of standard non-woven material, or meltblown or spunlace composites. An exemplary embodiment is a polypropylene non-woven or polypropylene/meltblown non-woven material.

The absorbent body, like the backing substrate above, can be any color and/or pattern that facilitates military and civilian applications. Examples of colors and/or patterns include, but are not limited to, black, white, khaki, and/or camouflage

The patient is placed on the absorbent body during transport. The absorbent body can have a top surface that does not adhere to the person, and that permits blood and body fluids to pass through to the absorbent or superabsorbent layers in the absorbent body.

The absorbent body and/or patient transporter may also contain one or more active agent. The active agent can be positioned anywhere on and/or in the absorbent body or patient transporter, to reduce infection and contamination by microbial pathogens, and to reduce and/or eliminate odors. The active agent is preferably positioned in and/or on the absorbent body. The one or more active agent can include, but is not limited to, a bactericide, bacteriostatic agent, fungicide, virucide, disinfectant, sanitizer, sterilizer, mildewstat, surfactant, deodorizer, or any combinations thereof. Examples of active agents include, but are not limited to, a: metal, metal compound, surface active agent, quaternary ammonium compound, organic acid, inorganic acid, salt, sulfite, biopolymer, synthetic polymer, chitin, chitosan, nisin, enzyme, arginate, diacetate, antioxidant, or any combinations thereof. An active agent may be present in its active form and/or present in an inactive form that is activated upon contact with other liquids, such as body fluids from the patient, or by external water or moisture.

In another embodiment of the patient transporter, the backing substrate has an additional exterior cover that is connected thereto, to form a pocket that completely encloses the expandable/deployable support structure of the present disclosure.

The patient transporter can also have a binding around the perimeter of the patient transporter that provides additional strength and/or a finished appearance to the transporter. An example of a binding includes, but is not limited to, a one inch (1″) nylon webbing material, which is sewn around the outer perimeter of the patient transporter.

The patient transporter can also have one or more gripping devices are positioned about the outer edges of the patient transporter to provide an easy handhold for the litter carrier(s). The gripping device can be in the backing substrate but unencumbered by the absorbent body; i.e., the absorbent body can have cut-outs around the gripping devices. The gripping device can be cutouts (holes) or straps connected to the transporter that permit the transporter to be manually lifted and carried during transport. Also, the gripping devices permit the transporter to be carried by one or more rigid bodies (such as poles) that can be inserted in the gripping devices. In one embodiment, the gripping devices are formed along the edges of patient transporter by loops of straps that extend across the entire width (or entire length) of the bottom surface of the patient transporter and extend beyond the edges.

Still other embodiments of a patient transporter of the present disclosure include a top cover. The top cover is placed over the patient during transport for safety and warmth. The top cover can have one or more pockets to hold medical paperwork, identification information, medications, clothing, and/or the patient's personal items.

The top cover can have a cut-out opening to fit around a patient's face and head during transport, so that a part or all of the patient's face and head are exposed while the patient's body is otherwise partially or completely covered by the top cover. The cut-out opening can also be called a “face portal,” “facial hole,” “face sock,” “face pocket,” and “face collar” interchangeably. The cut-out opening can have a padded collar around the perimeter of the cut-out opening to provide a snug, cushioned fit around the patient's face and head for patient comfort and to reduce the risk of loss of body heat and the risk of hypothermia. The top cover can also have a thermal liner and/or a reflective interior surface, such as MYLAR®, to further reduce the risk of hypothermia. The cut-out opening and/or collar can have a drawstring that can be pulled or loosened to provide a customized fit around the patient's face and head.

Alternatively, the closures for the top cover can be left open so that the patient's face remains exposed during transport, so that there is no need for a cut-out opening.

The top cover can be sewn so that the cut-out opening and collar are shaped to slope upward to conform more comfortably around the natural shape of the patient's neck and lower jaw.

The top cover can be made of a black nylon material. The underside of top cover can be a thermal liner. In an exemplary embodiment, the thermal liner is a reflective polyester film, such as MYLAR®, which assists in retaining body heat and reduces the risk of hypothermia.

The top cover can have one or more closures that allow access to the interior of patient transporter. The closures can include, but are not limited to, one or more zipper, hook, snap, adhesive tape, buttons, hook-and-loop fasteners (e.g., VELCRO®), rib-and-groove seals, or any combinations thereof. In a preferred embodiment, the closure is a zipper arranged in a curved configuration extending from one widthwise edge of the patient transporter to the opposite widthwise edge. Another exemplary embodiment of the top cover has a closure configured in an “R-curve” design that can be quickly opened and closed and provides wide access to the interior of the patient transporter.

In some embodiments, one or more securing straps having buckles or other devices to regulate tension can be attached to the patient transporter over the top cover to further secure the patient during transport

As noted above, the top cover protects the patient's body from inclement weather and conserves body heat to reduce the risk of hypothermia. The anti-hypothermia properties of the top cover can be enhanced by making the top cover from an insulating material, or layered to contain an insulating material therein. The top cover can be made of, or contain, one or more layers of an insulating material. Examples of insulating materials include, but are not limited to, fleece, nylon, cotton, wool, pile, polyester, polytetrafluoroethylene (PTFE), hollow-core polyester fibers, nylon/polyester blends, polyethylene, polypropylene, or any combinations thereof. These include commercially-available products such as GORE-TEX®, THERMO-LITE®, and CAMBRELLE®.

In other embodiments, the patient transporter can have an anti-hypothermia structure that is two or more material segments (also called cover layers) are connected along the lengthwise edge length of the patient transporter. The material segments are each folded approximately ⅔^{rds} of the distance across the width of the transporter, so as to overlap each other in the middle third section of transporter so that, when a person is placed on the transporter, the material segments act as a blanket to retain body heat and prevent hypothermia. Alternatively, the material segments can meet and be closed by a closure, such as a zipper or VELCRO.

The material segments can be made of one or more layers. The one or more material segments can include an outer layer, an inner layer, and an insulating layer positioned between the outer layer and the inner layer. The insulating layer can be a single layer, or can be two or more layers. The insulating later is made of one or more lightweight insulating materials that are selected from the group consisting of fleece, nylon, cotton, wool, pile, polyester, polytetrafluoroethylene (PTFE), hollow-core polyester fibers, nylon/polyester blends, polyethylene, polypropylene, and any combinations thereof. These include commercially-available products such as GORE-TEX®, THERMO-LITE®, and CAMBRELLE®. An embodiment of the transporter uses material segments having a 2, 4, or 6 ounce fleece with 210 nylon backing. The fleece functions to keep the person warm and reduce loss of body heat. The outer layer has a barrier material to protect against wind and/or wetness, and the barrier material includes, but is not limited to, nylon, polyethylene, polypropylene, polyester, nylon/polyester blend, cloth, polytetrafluoroethylene (PTFE), PTFE laminate, hollow-core polyester fiber, and any combinations thereof. The inner layer has a vapor-permeable layer to transfer moisture away from the person carried on the transporter. The inner layer is made of polyester, polyethylene, polypropylene, and any combinations thereof.

The anti-hypothermia properties of the patient transporter can be further enhanced by use of electrical or chemical warming devices. Warmers may be positioned anywhere in the transporter, such as in pockets within the backing substrate or material segments. The access slits may be used to insert the warming devices. Warming devices may be powered by batteries, or generate heat by chemical reactions.

For ease of carrying, one or more poles can be passed through the gripping devices, hand holes or straps to extend beyond the outer edges of the transporter for litter carriers to manually lift and transport the patient. Alternatively, the poles can also be passed through two or more of the gripping devices to manually lift and transport the patient. The poles can be made of metal, wood, polymer, and/or plastic. The poles can be solid, for stability and strength, or can be telescoping for ease of portability.

In other embodiments, the patient transporter may also have one or more access slits passing through the backing substrate, top cover, and/or material segments. The access slits provide access for medical personnel to the person being transported and provide passage for tubes needed to treat the person. Such slits are closeable, to provide a seal around any object passing through the access slits. Closures for access slits may be any closure means, such as hook and loop fasteners that are commercially available as VELCRO®

Further exemplary embodiments of patient transporters in which the expandable support structure of the present disclosure can be used have outer dimensions that are between about 18 inches (18″) (45.7 cm) to about forty-eight inches (48″) (121.9 cm) in width, by about sixty inches (60″) (152.4 cm) to about one-hundred-ten inches (110″) (279.4 cm) in length. In a preferred embodiment, the patient transporter has outer dimensions of about thirty-three inches (33″) (83.8 cm) in width by about seventy-eight (78″) (198.1 cm) in length. Another preferred embodiment is about twenty inches (20″) (50.8 cm) in width by about seventy-two inches (72″) (182.9 cm) in length. A more preferred embodiment of the patient transporter of the present disclosure has outer dimensions of about twenty-two inches (22″) (55.9 cm) in width by about seventy-six inches (76″) (193 cm) in length.

Alternative embodiments of the patient transporter is “half-sized” to carry children and small adults, having outer dimensions of about thirty-three inches (33″) (83.8 cm) in width (i.e., the same as for the full-size patient transporter) by about forty inches (40″) (101.6 cm) in length (i.e., about half of the length of a full-sized patient transporter). In such instances, the size of the expandable support structure can be scaled down proportionately to provide semi-rigid or rigid support to the “half-sized” patient transporter.

In each of these exemplary embodiments, the patient transporter is lightweight and portable. Prior to use, when the expandable support structure is not deployed, the patient transporter can be easily rolled up or folded for ease of portability, for example, to fit in canisters or rucksacks that are carried by medics, soldiers, or emergency medical personnel including canisters that are about six inches (6″) (15.2 cm), about eight inches (8″) (20.3 cm), and all diameters therebetween.

The patient transporter of the present disclosure is less than 10 pounds (4.5 kg) in total weight, and it is preferably less than 7 pounds (3.2 kg) in total weight, and more preferably is about 5 pounds (2.3 kg) or less in total weight. This is considerably less than conventional rigid litters, which are typically eighteen pounds (18 lbs.) (8.2 kg) to nineteen pounds (19 lbs.) (8.6 kg).

Even though the patient transporters having the expandable support structure are portable and lightweight, they are strong enough to support the full weight of a patient or soldier. An exemplary embodiment of the patient transporter of the present disclosure is able to support at least 300 lbs. (136.08 kg) of weight. Another exemplary embodiment of the patient transporter is able to support at least 350 lbs. (158.76 kg) of weight. Still another exemplary embodiment of the patient transporter is able to support at least 400 lbs. (181.44 kg) of weight. A further exemplary embodiment of the patient transporter is able to support at least 450 lbs. (204.12 kg) of weight. Yet another exemplary embodiment of the patient transporter is able to support more than 500 lbs. (227.3 kg) of weight, as shown in FIG. 32 (showing a test weight of 515 lbs.).

The patient transporter of the present disclosure is disposable after one use. Alternatively, the patient transporter can be re-used, for example, if the used absorbent body is removed and replaced. For ease of disposability, an embodiment of the absorbent body can be made of a biodegradable and/or compostable absorbent material, such as a starch-based absorbent or starch-based superabsorbent material, including, but not limited to, BioSAP™ (Archer-Daniels Midland, Decatur, Ill.).

In another embodiment, the patient transporter of the present disclosure has a smooth material segment called a skid plate (also called a “skid pad” or “material segment” in this application interchangeably) that is connected to the underside of the patient transporter. The skid plate provides a smooth outer surface that makes it easier for an individual carrier to pull or drag the patient transporter across land, water, snow, and/or sand or other rough terrain when carrying a patient thereon. For example, the skid plate permits the patient transporter to be pulled behind a skier over snow-covered surfaces. The skid plate can cover a part, or all, of the bottom (i.e., outer) surface of the patient transporter. In a preferred embodiment, the skid plate extends in a longitudinal direction across the entire length of the patient transporter (i.e., from one widthwise edge to the opposite widthwise edge). The skid plate is made of any solid material having a smooth surface that is strong and tear-resistant, including, but not limited to, polyvinyl chloride (PVC). In an exemplary embodiment, the skid plate is about ten inches (10″) (25.4 cm) to about eighteen inches (18″) (45.7 cm) in width, and is the same length to extend the entire lengthwise outer dimension of the patient transporter. In a preferred embodiment, the skid plate is about twelve inches (12″) (30.5 cm) to about fifteen inches (15″) (38.1 cm) in width. The skid plate is disposed on a center portion of the lower substrate, since the patient's body (and the patient's center of gravity) tend to collect toward the center axis of the patient transporter

The patient transporter with an expandable support structure to provide semi-rigid or rigid support is particularly well-suited for military use, because of its light weight, strength, ruggedness, and portability. The anti-hypothermia structure(s) on the top side of the transporter also make the patient transporter suitable for military use. The transporter is likewise useful for transporting injured civilians by first-response unit personnel, such as ambulances, helicopter rescue, firemen and forestry workers, where direct access to the site of injury by rescue units is difficult. Transporters of the present disclosure can also be easily stored for use where the numbers of injured persons is potentially large, such as at sports stadiums, airports, and large office buildings.

The patient transporter of the present disclosure can be made with little or no metal, and/or with a non-metallic coating around any metal parts, to reduce the risk of detection by a combatant on a military battlefield or in any hostile environment.

As used in this disclosure, “patient” is used to mean any person who is carried on a patient transporter, whether injured or ill, such as an injured soldier who is carried from a battlefield.

As used in this disclosure, “patient transporter,” “transporter,” “litter” and/or “stretcher” are used interchangeably without any change in meaning.

“Support,” as used herein, also means “rigidity” and/or “mechanical support.”

As used in this disclosure, the word “about” for dimensions, weights, and other measures, means a range that is ±10% of the stated value, more preferably is ±5% of the stated value, and most preferably is ±1% of the stated value, including all subranges therebetween.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

1. A patient transporter having a deployable support structure to provide additional rigidity and support for carrying a patient, comprising:
a backing substrate forming a portion of the back surface of the patient transporter; and
an expandable support structure on the backing substrate, the expandable support structure comprising:
an aperture joint having a plurality of apertures; and
a plurality of support rods slidable into the aperture joint;
wherein the expandable support structure can be deployed to provide additional rigidity to the patient transporter and to support the patient carried thereon.

2. The patient transporter according to claim 1, wherein the expandable support structure further comprises:
two aperture joints that are telescopically connected by the plurality of support rods passing through the plurality of apertures in the two aperture joints,
wherein the two aperture joints form three sections of the expandable support structure.

3. The patient transporter according to claim 2, wherein the expandable support structure, prior to deployment, is less than one-half of the length of the expandable support structure after deployment, and after deployment forms a semi-rigid patient transporter.

4. The patient transporter according to claim 1, wherein the expandable support structure comprises:
three aperture joints that are telescopically connected by the plurality of support rods passing through the plurality of apertures in the aperture joints,
wherein the three aperture joints form five sections of the expandable support structure.

5. The patient transporter according to claim 4, wherein the expandable support structure provides support under at least 80% of the length of the patient transporter after deployment to form a rigid patient transporter.

6. The patient transporter according to claim 1, wherein the expandable support structure provides additional rigidity and support directly beneath the patient's torso, head, and legs.

7. The patient transporter according to claim 1, wherein the aperture joint is a one-piece molded structure.

8. The patient transporter according to claim 1, wherein the plurality of apertures extend in a single longitudinal row.

9. The patient transporter according to claim 1, further comprising:
a stopper that limits expansion of the expandable support structure during deployment, wherein the stopper prevents the plurality of support rods from pulling out of the aperture joint.

10. The patient transporter according to claim 1, further comprising:
a lock under tension to maintain the expandable support structure in a fully-extended position after deployment.

11. The patient transporter according to claim 1, wherein each of the plurality of apertures further comprises a draft that reduces friction when the plurality of support rods slide through the aperture joint during deployment of the expandable support structure.

12. The patient transporter according to claim 1, wherein at least one of the plurality of apertures is molded to receive a doubled-up support rod.

13. The patient transporter according to claim 1, further comprising:
a pull cord connected to an end of the expandable support structure for deployment of the expandable support structure.

14. The patient transporter according to claim 1, further comprising:
straps or links as a handhold along the lengthwise and/or widthwise extents of the patient transporter.

15. The patient transporter according to claim 1, wherein the patient transporter has a top surface on the expandable support structure opposite the backing substrate, and the patient transporter further comprises:
a foam cushion between the expandable support structure and the top surface of the patient transporter.

16. The patient transporter according to claim 1, further comprising:
an anti-hypothermia structure connected to the patient transporter.

17. The patient transporter according to claim 1, further comprising:
an absorbent body positioned on and connected to the backing substrate,
wherein the absorbent body is sized less than the backing substrate so that a portion of the backing substrate forms an edge about a portion of the absorbent body, and
wherein the absorbent body can absorb a large amount of body fluids exuded from the patient carried thereon.

18. The patient transporter according to claim 1, further comprising:
an active agent selected from the group consisting of: bactericide, bacteriostatic agent, fungicide, virucide, disinfectant, sanitizer, sterilizer, mildewstat, surfactant, deodorizer, or any combinations thereof.

19. The patient transporter according to claim 1, further comprising:
a D-link connector; and
a strap,
wherein the D-link connector and strap assist in carting of the patient transporter.

20. (canceled)

21. A method for using a patient transporter having a deployable support structure for carrying a patient, comprising:
opening the transporter, wherein the transporter comprises:
a backing substrate forming a portion of the back surface of the patient transporter, the backing substrate having a top surface;
an absorbent body positioned on and connected to the top surface; and
an expandable support structure positioned between the backing substrate and the absorbent body, the expandable support structure comprising:
an aperture joint having a plurality of apertures; and
a plurality of support rods slidable into the aperture joint,
wherein the expandable support structure is deployed to provide additional rigidity and support to the patient carried on the patient transporter, and
wherein when the patient is placed on the absorbent body on the transporter, the absorbent body contacts only the back portion of the patient carried thereon to absorb exuded body fluids.
